(19) United States
(12) Patent Application Publication
(10) Pub. No.: US 2012/0320056 A1
(43) Pub. Date: Dec. 20, 2012

(54) THREE DIMENSIONAL IMAGE DISPLAY DEVICE AND METHOD OF DRIVING THE SAME

(75) Inventors: Ik Hyun AHN, Hwaseong-gi (KR); Seon Ki KIM, Anyang-si (KR); Se Huhn HUR, Yongin-si (KR); Jun Pyo LEE, Asan-si (KR); Bong Im PARK, Asan-si (KR)

(73) Assignee: SAMSUNG ELECTRONICS CO., LTD., Suwon-si (KR)

(21) Appl. No.: 13/286,438

(22) Filed: Nov. 1, 2011

(30) Foreign Application Priority Data
Jun. 17, 2011 (KR) 10-2011-0059201

(51) Int. Cl. G06T 15/50; G06T 15/00

(52) U.S. Cl. 345/426

(57) ABSTRACT

A three dimensional image display device includes a display panel and a backlight unit. The display panel displays a left eye image and a right eye image of an image inputted to the display panel, in sequence. The backlight unit includes a plurality of backlight blocks. In the three dimensional image display device, based on at least one of depth information from the objects of the left eye and right eye images, and edge information from the object the left eye image or the right eye image, brightness of the plurality of backlight blocks are independently controlled.

This application claims priority to Korean Patent Application No. 10-2011-0059201 filed on Jun. 17, 2011, and all the benefits accruing therefrom under 35 U.S.C.§119, the entire contents of which are incorporated herein by reference.

### BACKGROUND OF THE INVENTION

(a) Field of the Invention

A three-dimensional (“3D”) image display device and a method of driving the same are provided.

(b) Description of the Related Art

In general, in a 3D image display technology, a stereoscopic perception of an object is represented by using a binocular parallax as the largest factor for recognizing the stereoscopic perception in a near distance. In other words, when different two-dimensional (“2D”) images are reflected in a left eye and a right eye, respectively, and the image reflected in the left eye (hereinafter, referred to as a “left eye image”) and the image reflected in the right eye (hereinafter, referred to as a “right eye image”) are transferred to a brain, the left eye image and the right eye image are combined in the brain to be recognized as the 3D image having depth perception.

A 3D image display device uses the binocular parallax and includes a stereoscopic method using glasses such as shutter glasses, polarized glasses, or the like and an autostereoscopic method in which lenticular lens and parallax barrier, or the like is disposed in a display device without using glasses.

In the shutter glasses type, the left eye image and the right eye image are divided to be continuously outputted in the 3D image display device, and a left eye shutter and a right eye shutter of the shutter glasses are selectively open and closed, thereby expressing the 3D image.

In the shutter glasses type, a 2D mode and a 3D mode are easily switched and data loss is not present in each mode. However, when a difference between grays of the left eye image and the right eye image is large, a crosstalk effect may occur.

### BRIEF SUMMARY OF THE INVENTION

An exemplary embodiment of the invention provides a three dimensional image display device including: a display panel which displays a left eye image and a right eye image of an image inputted to the display panel, in sequence; and a backlight unit including a plurality of backlight blocks. The left eye image and the right eye image respectively including an object. In the three dimensional image display device, based on at least one of depth information from the objects of the left eye and right eye images, and edge information from the object of the left eye image or the right eye image, brightness of the plurality of backlight blocks is independently controlled.

When the object of the left eye image and the object of the right eye image are the same as each other, and a difference between a gray of the object of the left eye image and a gray of the object of the right eye image or a difference between a gray in an edge of the object of the left eye image and a gray in an edge of the object of the right eye image is greater than a predetermined gray, the brightness of a backlight block corresponding to the object of the left eye image and the object of the right eye image may decrease.

When the difference between the gray of the object of the left eye image and the gray of the object of the right eye image or the difference between the gray in the edge of the object of the left eye image and the gray in the edge of the object of the right eye image is smaller than the predetermined gray, the brightness of the backlight block corresponding to the object of the left eye image and the object of the right eye image may increase.

The left eye image and the right eye image may include a first region without depth perception, and a gray of the first region may be compensated.

The brightness of the plurality of backlight blocks may be independently controlled based on brightness distribution of the left eye image or brightness distribution of the right eye image.

A gray of the image inputted to the display panel may be controlled based on at least one of the depth information from the objects of the left eye and right eye images of the image inputted to the display panel, and the edge information from the object of the left eye image or the right eye image of the image inputted to the display panel.

When the object of the left eye image and the object of the right eye image are the same as each other, and a difference between a gray of the object of the left eye image and a gray of the object of the right eye image or a difference between a gray in an edge of the object of the left eye image and a gray in an edge of the object of the right eye image is greater than a predetermined gray, the gray of the object of the left eye image or the gray of the object of the right eye image may be controlled so as to reduce the difference between the gray of the object of the left eye image and the gray of the object of the right eye image.

When the difference between the gray of the object of the left eye image and the gray of the object of the right eye image or a difference between the gray in the edge of the object of the left eye image and the gray in the edge of the object of the right eye image is smaller than the predetermined gray, the gray of the object of the left eye image and the gray of the object of the right eye image may not be controlled.

The backlight unit may be on at least one side of the display panel in the plan view.

A gray of the image inputted to the display panel may be controlled based on at least one of a gray average value of the object of the left eye image or the right eye image, a gray minimum value of the object of the left eye image or the right eye image, a gray maximum value of the object of the left eye image or the right eye image, a high gray average value of the object of the left eye image or the right eye image, and a low gray average value of the object of the left eye image or the right eye image.

Another exemplary embodiment of the invention provides a driving method of a three dimensional image display device, the method including: displaying a left eye image and a right eye image of an image inputted to a display panel, in sequence; and independently controlling brightness of a plurality of backlight blocks based on at least one of depth information from the objects of the left eye and right eye images, and edge information from the object of the left eye image or the right eye image.

### BRIEF DESCRIPTION OF THE DRAWINGS

The above and other features of this disclosure will become more apparent by describing in further detail exemplary embodiments thereof with reference to the accompanying drawings, in which:

FIG. 1 is a schematic diagram illustrating an exemplary embodiment of an operation of a three dimensional image display device according to the invention.

FIG. 2 is a schematic diagram illustrating an exemplary embodiment of a three dimensional image display device according to the invention.

FIG. 3 is a schematic diagram illustrating an exemplary embodiment a display panel and a backlight unit according to the invention.

FIG. 4 is a schematic diagram illustrating another exemplary embodiment of a display panel and a backlight unit according to the invention.

FIG. 5 is a schematic diagram illustrating another exemplary embodiment of a three dimensional image display device according to the invention.

FIG. 6 is a signal waveform diagram of an exemplary embodiment of a three dimensional image display device according to the invention.

FIG. 7 is a signal waveform diagram of another exemplary embodiment of a three dimensional image display device according to the invention.

FIG. 8 is a signal waveform diagram of another exemplary embodiment of a three dimensional image display device according to the invention.

FIG. 9 is a signal waveform diagram of another exemplary embodiment of a three dimensional image display device according to the invention.

### DETAILED DESCRIPTION OF THE INVENTION

The invention will be described more fully hereinafter with reference to the accompanying drawings, in which exemplary embodiments of the invention are shown. As those skilled in the art would realize, the described embodiments may be modified in various different ways, all without departing from the spirit or scope of the invention. The drawings and description are to be regarded as illustrative in nature and not restrictive. Like reference numerals designate like elements throughout the specification. Further, a detailed description of the related art that has been widely known is omitted.

In the drawings, the thickness of layers, films, panels, regions, etc., are exaggerated for clarity. It will be understood that when an element such as a layer, film, region, or substrate is referred to as being “on” another element, it can be directly on the other element or intervening elements may also be present. In contrast, when an element is referred to as being “directly on” another element, there are no intervening elements present. As used herein, “connected” includes physically and/or electrically connected. Like numbers refer to like elements throughout. As used herein, the term “and/or” includes any and all combinations of one or more of the associated listed items.

It will be understood that, although the terms first, second, third, etc., may be used herein to describe various elements, components, regions, layers and/or sections, these elements, components, regions, layers and/or sections should not be limited by these terms. These terms are only used to distinguish one element, component, region, layer or section from another region, layer or section. Thus, a first element, component, region, layer or section discussed below could be termed a second element, component, region, layer or section without departing from the teachings of the invention.

The terminology used herein is for the purpose of describing particular embodiments only and is not intended to be limiting of the invention. As used herein, the singular forms “a,” “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

Unless otherwise defined, all terms (including technical and scientific terms) used herein have the same meaning as commonly understood by one of ordinary skill in the art to which this invention belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

All methods described herein can be performed in a suitable order unless otherwise indicated herein or otherwise clearly contradicted by context. The use of any and all examples, or exemplary language (e.g., “such as”), is intended merely to better illustrate the invention and does not pose a limitation on the scope of the invention unless otherwise claimed. No language in the specification should be construed as indicating any non-claimed element as essential to the practice of the invention as used herein.

Hereinafter, the invention will be described in detail with reference to the accompanying drawings.

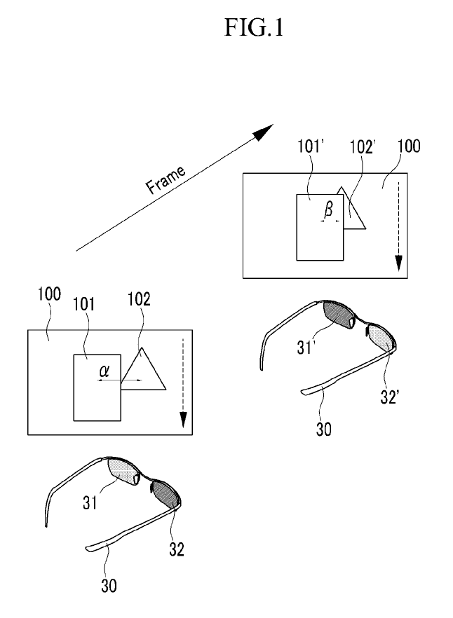

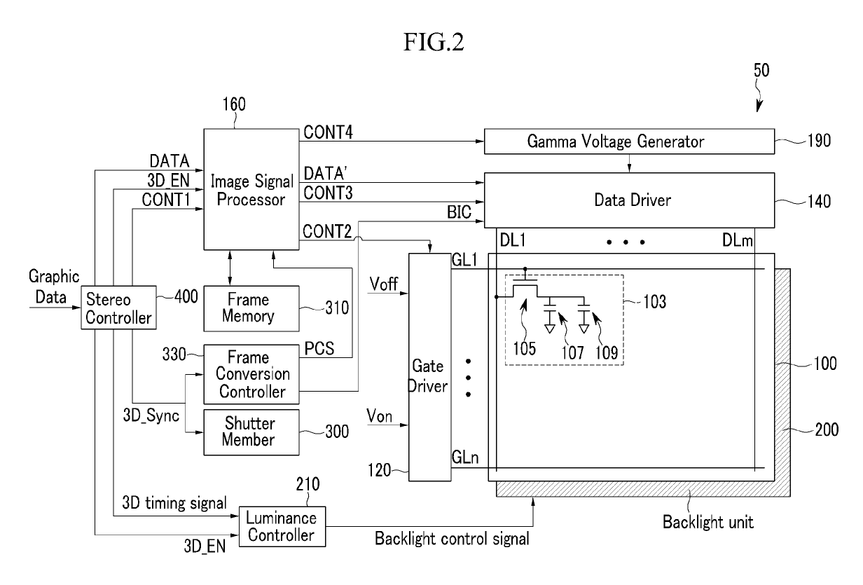

FIG. 1 is a schematic diagram illustrating an exemplary embodiment of an operation of a three dimensional (“3D”) image display device according to the invention, and FIG. 2 is a schematic diagram illustrating an exemplary embodiment of a 3D image display device according to the invention.

A display panel 100 may include a liquid crystal display, an organic light emitting diode (“LED”) display, a plasma display device, an electrophoretic display, or the like. Hereinafter, it is assumed that the display panel 100 is the liquid crystal display.

The display panel 100 may include an upper substrate, a lower substrate, and a liquid crystal layer injected between the upper substrate and the lower substrate. An alignment direction of a liquid crystal of the liquid crystal layer is changed by an electric field generated between two electrodes, such that the display panel 100 displays images by controlling the transmission amount of light.

The lower substrate includes gate lines GL1 to GLn, data lines DL1 to DLm, a pixel electrode, and a thin film transistor 105 connected thereto. The thin film transistor 105 controls the voltage applied to the pixel electrode based on a signal applied to the gate lines GL1 to GLn and the data lines DL1 to DLm. The pixel electrode may be a transflective pixel electrode having a transmittive region and a reflective region. The display panel 100 may further include a storage capacitance capacitor 107 which maintains the voltage applied to the pixel electrode for a predetermined time. In one exemplary embodiment, for example, one pixel 103 may include the thin film transistor 105, the storage capacitance capacitor 107, and a liquid crystal capacitance capacitor 109.

The upper substrate of the display panel 100 facing the lower substrate may include a black matrix, a color filter, and a common electrode. In addition, at least one of the black matrix, the color filter, and the common electrode of the upper substrate may be disposed on the lower substrate. When both the common electrode and the pixel electrode are disposed on the lower substrate, at least one of the common electrode and the pixel electrode may be formed in a linear electrode form.

The liquid crystal layer may include a twisted nematic (“TN”) mode liquid crystal, a vertically aligned (“VA”) mode liquid crystal, and an electrically controlled birefringence (“ECB”) mode liquid crystal, or the like.

A polarizer is attached to at least one of the outer side of the upper substrate and the outer side of the lower substrate of the display panel 100. Further, a compensation film is further formed between the substrate and the polarizer.

A backlight unit 200 includes a light source, and an example of the light source is a fluorescent lamp such as a cold cathode fluorescent lamp (“CCFL”), an LED, or the like. In addition, the backlight unit 200 may further include a reflector, a light guide, a luminance improve film, and the like.

Referring to FIG. 2, a display apparatus 50 may include the display panel 100, the backlight unit 200, a data driver 140, a gate driver 120, an image signal processor 160, a gamma voltage generator 190, a luminance controller 210, a shutter member 300, a frame memory 310, a frame conversion controller 330, a stereo controller 400, and the like. The stereo controller 400 receives graphic data from an external source. The stereo controller 400 may transmit a 3D timing signal and a 3D enable signal 3D_EN to the luminance controller 210. The luminance controller 210 may transmit a backlight control signal to the backlight unit 200.

The backlight unit 200 may be turned on or off by the backlight control signal through the luminance controller 210 and the stereo controller 400. When a duty ratio of the backlight control signal is large, the backlight unit 200 may be brightly turned on and when the duty ratio of the backlight control signal is small, the backlight unit 200 may be darkly turned on. The duty ratio means a ratio of a high level duration of the backlight control signal to one cycle. The backlight control signal transmitted to the backlight unit 200 may turn on the backlight unit 200 for a predetermined time. In one exemplary embodiment, for example, the backlight control signal transmitted to the backlight unit 200 may turn on the backlight unit 200 for a vertical blank (“VB”) or for a remaining time other than the VB.

The stereo controller 400 may transmit a 3D sync signal 3D_Sync to the shutter member 300 and to the frame conversion controller 330. The shutter member 300 may be electrically connected with the stereo controller 400. The shutter member 300 may receive the 3D sync signal 3D_Sync by a wireless infrared communication. The shutter member 300 may be operated in response to the 3D sync signal 3D_Sync or a modified 3D sync signal. The 3D sync signal 3D_Sync may include all signals capable of opening or closing a left eye shutter or a right eye shutter. The frame conversion controller 330 may transmit control signals PCS and BIC to the image signal processor 160 and the data driver 140, respectively.

The stereo controller 400 may transmit a display data DATA, the 3D enable signal 3D_EN, and a control signals CONT1 to the image signal processor 160. The image signal processor 160 may transmit various kinds of display data DATA′ and various kinds of control signals CONT2, CONT3, and CONT4 to the display panel 100 through the gate driver 120, the data driver 140, and the gamma voltage generator 190 in order to display images on the display panel 100. The display data DATA in the 3D image display device may include a left eye image data, a right eye image data, and the like.

The stereo controller 400, the image signal processor 160, or the luminance controller 210 may perform a spatial filter and a temporal filter.

Referring to FIG. 1, the shutter member 300 may be stereoscopic shutter glasses 30, but is not particularly limited thereto, and may include mechanical shutter glasses (e.g., goggles), optical shutter glasses, or the like. The shutter glasses 30 are formed so that right eye shutters 32 and 32′ and left eye shutters 31 and 31′ block the light in turn with a predetermined cycle by synchronizing with the display panel 100. The right eye shutter may be a closed state 32 or an open state 32′ and the left eye shutter may be an open state 31 or a closed state 31′. In one exemplary embodiment, for example, while the right eye shutter is open, the left eye shutter may be closed and conversely, while the left eye shutter is open, the right eye shutter may be closed. Further, both the left eye shutter and the right eye shutter may be open or closed at the same time.

The shutters of the shutter glasses 30 may be formed by a technology used in a liquid crystal display, an organic light emitting diode display, an electrophoretic display, and the like, but is not particularly limited thereto. In one exemplary embodiment, for example, the shutter may include two transparent conductive layers and a liquid crystal layer disposed therebetween. A polarization film may be disposed on the surface of the conductive layer. A liquid crystal material of the liquid crystal layer is rotated by the voltage applied to the shutter and the shutter may be open or closed by the rotation of the liquid crystal material.

As illustrated in the exemplary embodiment of FIG. 1, for example, left eye images 101 and 102 are outputted on the display panel 100, the left eye shutter 31 of the shutter glasses 30 is open so as to transmit the light, and the right eye shutter 32 is closed so as to block the light. In addition, right eye images 101′ and 102′ are outputted on the display panel 100, the right eye shutter 32′ of the shutter glasses 30 is open so as to transmit the light, and the left eye shutter 31′ is closed so as to block the light. Accordingly, the left eye images 101 and 102 are recognized by only the left eye of an observer for a predetermined time and thereafter, the right eye images 101′ and 102′ are recognized by only the right eye of the observer for a predetermined time, such that 3D images having depth perception are recognized by a difference between the left eye image and the right eye image.

The image inputted to the display panel 100 and recognized by the left eye is an image in which a quadrangle 101 and a triangle 102 are spaced apart from each other by a distance of α. The image inputted to the display panel 100 and recognized by the right eye is an image in which a quadrangle 101′ and a triangle 102′ are spaced apart from each other by a distance of β. Herein, α and β may have different values and as a result, the distance perception of the triangle to the quadrangle may be felt different such that the depth perception of the triangle disposed at the rear of the quadrangle may be felt. By controlling distances α and β between the triangle and the quadrangle, the distance in which the triangle and the quadrangle are separated from each other (depth perception) may be controlled.

An image having a predetermined gray value may be displayed between the left eye images 101 and 102 and the right eye images 101′ and 102′. In one exemplary embodiment, for example, a black image, a white image, a gray image, or the like may be displayed. When the image having a predetermined gray value is inserted on the overall screen of the display device, a crosstalk effect between the left eye images 101 and 102 and the right eye images 101′ and 102′ may be reduced.

Referring to FIG. 1, an arrow direction shown in the display panel 100 represents an order in which gate-on voltage (Von) is applied to a plurality of gate lines substantially extending in a column direction. In other words, gate-on signals are applied from an upper gate line of the display panel 100 to a lower gate line in sequence.

In one exemplary embodiment, for example, the display panel 100 may display the left eye images 101 and 102 as described below. In sequence, the gate-on voltage is applied to the gate line, and the data voltage is applied to the pixel electrode through the thin film transistor connected to the corresponding gate line. The applied data voltage is data voltage (hereinafter, referred to as “left eye data voltage”) for expressing the left eye images 101 and 102, and the applied left eye data voltage may be maintained for a predetermined time by the storage capacitance capacitor 107. Similarly, data voltage (hereinafter, referred to as “right eye data voltage”) for expressing the right eye images 101′ and 102′ is applied to the pixel electrode, and the applied right eye data voltage may be maintained for a predetermined time by the storage capacitance capacitor 107.

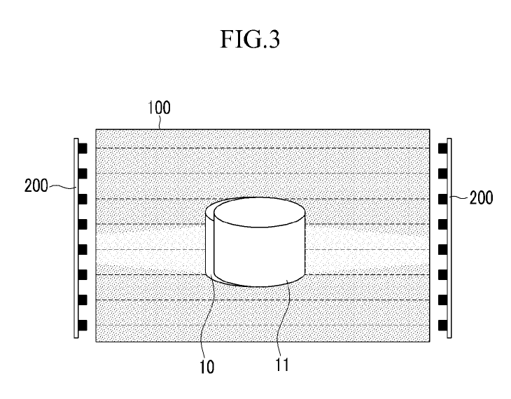

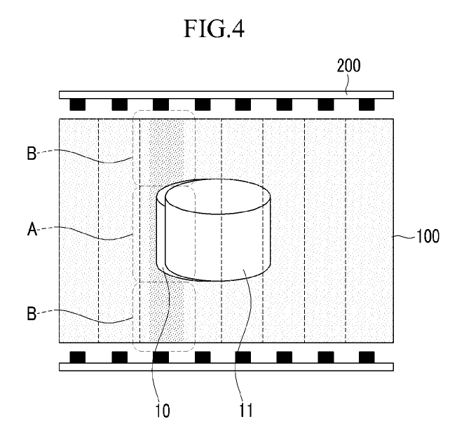

FIG. 3 is a schematic diagram illustrating an exemplary embodiment of a display panel and a backlight unit according to the invention, and FIG. 4 is a schematic diagram illustrating another exemplary embodiment of a display panel and a backlight unit according to the invention.

The backlight unit 200 is disposed on at least one of four sides of a display panel 100, in a plan view of the display panel 100. As exemplary embodiments, referring to FIGS. 3 and 4, the backlight unit 200 is disposed at left and right sides or upper and lower sides of the display panel 100. In addition, the backlight unit 200 may be disposed only in a left direction of the display panel 100, only in a right direction thereof, only in an upper direction thereof, or only in a lower direction thereof. In FIGS. 3 and 4, the backlight unit 200 includes eight blocks on a base, but the number of blocks of the backlight unit 200 is not limited to eight and may be variously modified. An object 10 displayed in the right eye image and an object 11 displayed in the left eye image are separated from each other by a predetermined distance, such that depth perception occurs.

The backlight unit 200 may independently control brightness of the blocks of the backlight unit 200 based on depth information from the left eye image and the right eye image. In an edge region A at which the depth perception occurs, when a difference between a gray of the left eye image including object 10 and a gray of the right eye image including object 11 is larger than a predetermined gray, the backlight unit 200 at the corresponding edge region of the image inputted to the display panel 100 and may be darkly controlled, such that the crosstalk effect of the left eye image and the right eye image may be reduced. In consecutive frames, when a difference in grays in a region is large, an actual gray in the region does not reach a target gray due to a slow response speed of the liquid crystal, such that the backlight unit 200 in the region may be darkly controlled. A predetermined value of the gray may be properly controlled based on a response speed of the liquid crystal, and the predetermined value of the gray may be larger in a fast response speed of the liquid crystal than in a low response speed of the liquid crystal.

In the edge region A at which depth perception occurs, when a difference between a gray of the left eye image including object 10 and a gray of the right eye image including object 11 is smaller than a predetermined gray, the backlight unit 200 at the corresponding edge region of the image inputted to the display panel 100 and may be brightly controlled, such that the luminance of the 3D image display device may increase.

A gray in a region B at which depth perception does not occur may be compensated. In one exemplary embodiment, for example, the gray in the region B without the depth perception may increase when the backlight unit 200 at the region B without the depth perception is darkly controlled, and the gray in the region B without the depth perception may decrease when the backlight unit 200 at the region B without the depth perception is brightly controlled. A gray in the edge region A with the depth perception may be calculated by using the image stored in the frame memory 310.

Without calculating depth information from the left eye image and the right eye image, edge information of the object may be extracted from any one of the left eye image and the right eye image, respectively, through a filter such as a high pass filter or the like, and the brightness of the backlight unit 200 may be controlled based on the edge information. In one exemplary embodiment, for example, when a difference between the gray of the edge region of the object in the left eye image and the gray of the edge region of the object in the right eye image is larger than a predetermined gray, the backlight unit 200 at the edge region of the image inputted to the display panel 100 may be darkly controlled, such that the crosstalk effect of the left eye image and the right eye image may be reduced. When a difference between the gray of the edge region of the object in the left eye image and the gray of the edge region of the object in the right eye image is smaller than a predetermined gray, the backlight unit 200 in the edge region of the image inputted to the display panel 100 may be brightly controlled, such that the luminance of the 3D image display device may increase. In addition, a gray of any region other than the edge region of the object may be compensated. When the edge information is used as compared with the depth information, an operation amount of the 3D image display device is small, such that an operation processing speed of the 3D image display device may be improved and the cost may be reduced.

The gray of the image may be controlled based on the depth information of the left eye image and the right eye image. The gray control is also referred to as a gray clipping. In the edge region A at which the depth perception occurs, when a difference between a gray of the left eye image and a gray of the right eye image is larger than a predetermined gray, the gray in the current frame may be controlled so as to reduce the gray difference, such that the crosstalk effect of the left eye image and the right eye image may be reduced. In consecutive frames, when a difference of grays in a region is large, an actual gray in the region does not reach a target gray due to a slow response speed of the liquid crystal, such that the grays in the region may be controlled. A predetermined value of the gray may be properly controlled based on the response speed of the liquid crystal and the predetermined value of the gray may be greater in a fast response speed of the liquid crystal than in a low response speed of the liquid crystal. In one exemplary embodiment, for example, when the gray is converted from a black, 0, to a white, 1023, the gray does not reach 1023 due to the slow response speed of the liquid crystal, such that due to the gray clipping, a lowered gray from about 800 to about 840 may be performed.

In the edge region A at which the depth perception occurs, when a difference between a gray of the left eye image and a gray of the right eye image is smaller than a predetermined gray, the gray in the corresponding edge region may not be controlled. In one exemplary embodiment, for example, when the gray is converted from a gray 200 to a white, 1023, the gray clipping may not be performed because the gray reaches 1023.

The gray of the image may be controlled based on the edge information on the object in the left eye image or the right eye image. The edge information on the object may be extracted through a filter such as a high pass filter or the like. In one exemplary embodiment, for example, when a difference between the gray of the edge region of the object in the left eye image and the gray of the edge region of the object in the right eye image is larger than a predetermined gray, the gray of the edge region of the image inputted to the display panel 100 in the current frame may be controlled so as to reduce the gray difference, such that the crosstalk effect of the left eye image and the right eye image may be reduced. When a difference between the gray of the edge region of the object in the left eye image and the gray of the edge region of the object in the right eye image is smaller than a predetermined gray, the gray of the edge region of the image inputted to the display panel 100 in the current frame may not be controlled. When the edge information is used as compared with the depth information, an operation amount of the 3D image display device is small, such that an operation processing speed of the 3D image display device may be improved and the cost may be reduced.

A gray of the image may be controlled based on a gray average value, a gray minimum value, a gray maximum value, a high gray average value, or a low gray average value of a predetermined region in the left eye image or the right eye image. In one exemplary embodiment, for example, when a difference between the gray average value of the predetermined region in the left eye image and the gray average value of the predetermined region in the right eye image is larger than a predetermined gray, the gray of the edge region in the current frame may be controlled so as to reduce the gray difference. Similarly, when a difference in the gray minimum values, a difference in the gray maximum values, a difference in the high gray average values, or a difference in the low gray average values is larger than a predetermined gray, the gray of the edge region of the image inputted to the display panel 100 in the current frame may be controlled so as to reduce the gray difference. The high gray average value means an average value of the grays having a predetermined value or more, and the low gray average value means an average value of the grays having a predetermined value or less.

Based on the depth information, the edge information, the average value, the minimum value, the maximum value, the high gray average value, or the low gray average value, the gray clipping may be locally performed only at a predetermined region of the image inputted to the display panel 100 where the gray clipping is required, such that luminance of the 3D image display device may be increased and image quality may be improved.

Based on brightness distribution of the left eye image or the right eye image, brightness for backlight blocks may be differently controlled. In one exemplary embodiment, for example, when an image is divided into an upper region, a middle region, and a lower region, brightness of the backlight block for each region may be independently controlled.

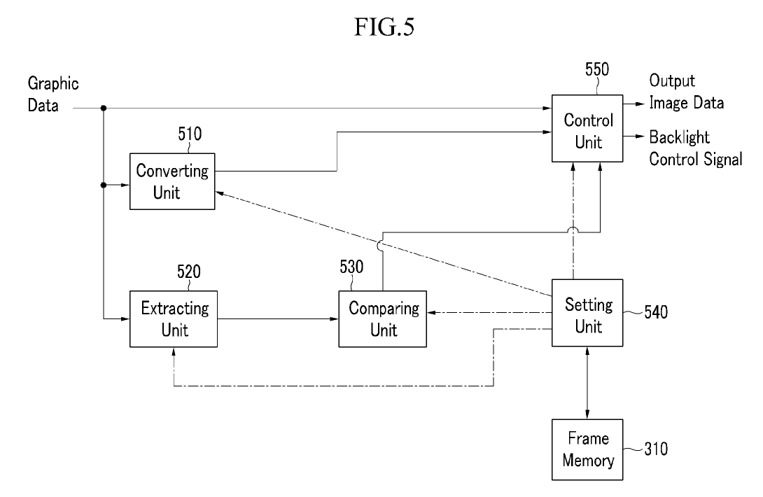

FIG. 5 is a schematic diagram illustrating another exemplary embodiment of a 3D image display device according to the invention.

Referring to FIG. 5, a 3D image display device includes a converting unit 510, an extracting unit 520, a comparing unit 530, a setting unit 540, and a control unit 550, and at least one of the units may be embedded in the stereo controller 400, the image signal processor 160, or the luminance controller 210.

The converting unit 510 may clip an input image and perform processes such as normalization, gamma correction, and the like so that target gray voltage may be outputted based on the clipped gray. The converting unit 510 may perform a technology such as data expansion, dithering, or the like. The converting unit 510 may be implemented based on an equation or a look-up table.

The extracting unit 520 may extract depth information, edge information, an average value, a minimum value, a maximum value, a high gray average value, or a low gray average value which is required in the comparing unit 530.

The comparing unit 530 compares a value transmitted from the extracting unit 520 and a threshold value transmitted from the setting unit 540 so as to determine whether or not to perform a gray clipping or whether or not to control the brightness of a backlight unit of the 3D image display device. The threshold value may be a predetermined gray value.

The setting unit 540 reads values required in each unit from a frame memory 310 and then, transmits the read values to each unit 510, 520, 530 and 550. The frame memory 310 may be an external memory or an internal memory.

The control unit 550 outputs images based on the input image and the gray clipped image. The control unit 550 outputs the backlight control signal based on the depth information and the edge information.

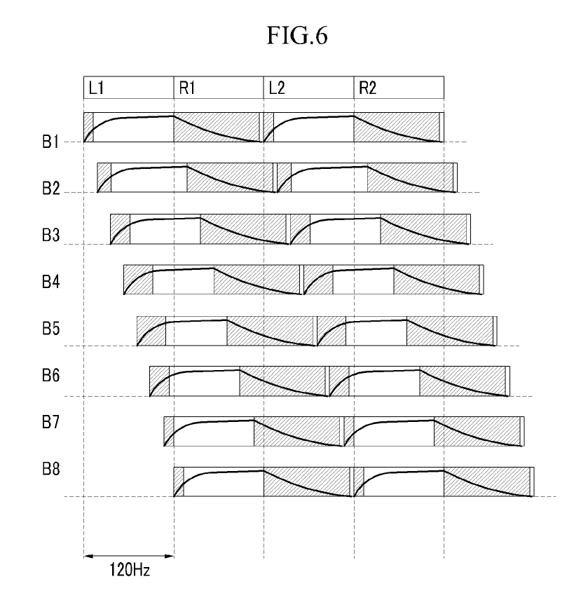

FIG. 6 is a signal waveform diagram of an exemplary embodiment of a 3D image display device according to the invention.

Referring to FIG. 6, left eye images L1 and L2 and right eye images R1 and R2 are alternately inputted based on a frame frequency of 120 hertz (Hz). In one exemplary embodiment, for example, a white left eye image having a 1023 gray and a black right eye image having a 0 gray are alternately inputted. The backlight unit 200 in FIG. 6 is disposed at a left side, a right side, or both left and right sides of the display panel 100 and is divided into eight blocks B1 to B8. The eight backlight blocks B1 to B8 brighten to a brightness of 100% in sequence in accordance with a scanning direction of the 3D image display device.

A curve in FIG. 6 means gray variation in the image. A slash marked portion in the backlight blocks B1 to B8 in FIG. 6 means that the backlight unit 200 is turned off and a non-slash-mark portion means that the backlight unit 200 has the maximum brightness. Since an image analysis of a first left eye image L1 is completed at the time when an input of the first left eye image L1 ends, information on a duty ratio of the backlight unit 200 to the first left eye image L1 is stored and then, luminance of the backlight unit 200 to a second left eye image L2 may be controlled based on the information on the duty ratio.

The brightness of the backlight unit 200 for each frame may be independently controlled based on the depth information or the edge information of the input image. In addition, the brightness of each backlight block may be independently controlled even in the same frame based on the depth information or the edge information of the input image. In order to compensate light diffusion deviation, the brightness of each backlight block may be independently controlled in the same frame based on a brightness distribution of the left eye image or the right eye image. In the illustrated embodiment, for example, referring to FIG. 6, duty ratios of a first backlight block B1 and a fourth backlight block B4 are different from each other.

When a 3D image is inputted, a cycle of the duty ratio of the backlight unit 200 may be controlled based on a frame frequency. In the illustrated embodiment, for example, when the frame frequency is 120 Hz, the cycle of the duty ratio of the backlight unit 200 is the same as a one frame cycle in both the case where a two-dimensional (“2D”) image is inputted and the case where the 3D image is inputted. When the frame frequency is 240 Hz, the cycle of the duty ratio of the backlight unit 200 is the same as the one frame cycle in the case where the 2D image is inputted, but the cycle of the duty ratio of the backlight unit 200 is the same as a two frame cycle in the case where the 3D image is inputted. When the frame frequency is 480 Hz, the cycle of the duty ratio of the backlight unit 200 is the same as the one frame cycle in the case where the 2D image is inputted, but the cycle of the duty ratio of the backlight unit 200 is the same as a four frame cycle in the case where the 3D image is inputted.

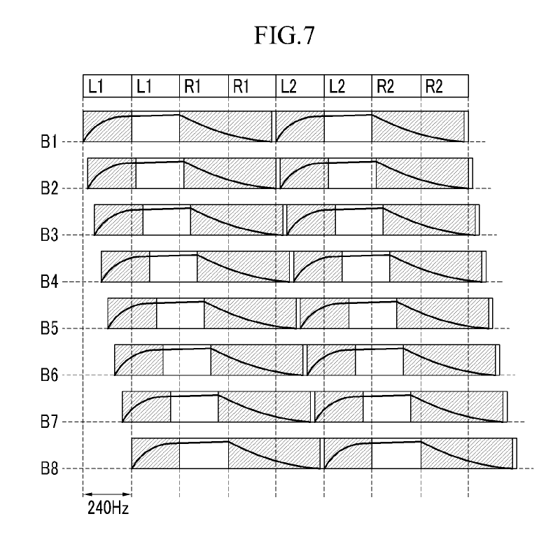

FIG. 7 is a signal waveform diagram of another exemplary embodiment of a 3D image display device according to the invention.

Referring to FIG. 7, left eye images L1 and L2 and right eye images R1 and R2 are alternately inputted based on a frame frequency of 240 Hz. A first left eye image L1 is continuously inputted two times and then, a first right eye image R1 is continuously inputted two times. Next, a second left eye image L2 is continuously inputted two times and then, a second right eye image R2 is continuously inputted two times. In one exemplary embodiment, for example, a white left eye image having a 1023 gray is continuously inputted two times and then, and a black right eye image having a 0 gray is continuously inputted two times. The backlight unit 200 in FIG. 7 is disposed at a left side, a right side, or both left and right sides of a display panel 100 and is divided into eight blocks B1 to B8. The eight backlight blocks B1 to B8 brighten to a brightness of 100% in sequence in accordance with a scanning direction of the 3D image display device.

A curve in FIG. 7 means gray variation in the image. A slash marked portion in the backlight blocks B1 to B8 in FIG. 7 means that the backlight unit 200 is turned off and a non-slash-mark portion means that the backlight unit 200 has the maximum brightness. Information on a duty ratio of the backlight unit 200 based on the first left eye image L1 is delayed by 4 frames, such that luminance of the backlight unit 200 for a second left eye image L2 may be controlled based on the information on the duty ratio. In addition, after only the first left eye image L1 is analyzed, one frame is delayed, such that luminance of the backlight unit 200 to the immediately subsequent first left eye image L1 may be controlled.

The brightness of the backlight unit 200 for each frame may be independently controlled based on the depth information or the edge information of the input image. In addition, the brightness of each backlight block may be independently controlled even in the same frame based on the depth information or the edge information of the input image. In order to compensate light diffusion deviation, the brightness of each backlight block may be independently controlled in the same frame based on a brightness distribution of the left eye image or the right eye image.

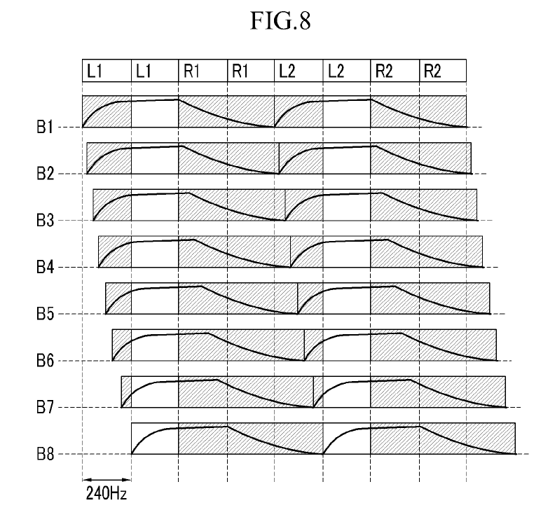

FIG. 8 is a signal waveform diagram of another exemplary embodiment of a 3D image display device according to the invention.

Referring to FIG. 8, left eye images L1 and L2 and right eye images R1 and R2 are alternately inputted based on a frame frequency of 240 Hz. A first left eye image L1 is continuously inputted two times and then, a first right eye image R1 is continuously inputted two times. Next, a second left eye image L2 is continuously inputted two times and then, a second right eye image R2 is continuously inputted two times. In one exemplary embodiment, for example, a white left eye image having a 1023 gray is continuously inputted two times and then, and a black right eye image having a 0 gray is continuously inputted two times. The backlight unit 200 in FIG. 8 is disposed at an upper side, a lower side, or both upper and lower sides of a display panel 100 and is divided into eight blocks B1 to B8. The eight backlight blocks B1 to B8 brighten to a brightness of 100% at the same time.

A curve in FIG. 8 means gray variation in the image. A slash marked portion in the backlight blocks B1 to B8 in FIG. 8 means that the backlight unit 200 is turned off and a non-slash-mark portion means that the backlight unit 200 has the maximum brightness.

The brightness of the backlight unit 200 for each frame may be independently controlled based on the depth information or the edge information of the input image. In addition, the brightness of each backlight block may be independently controlled even in the same frame based on the depth information or the edge information of the input image. In order to compensate light diffusion deviation, the brightness of each backlight block may be independently controlled in the same frame based on a brightness distribution of the left eye image or the right eye image.

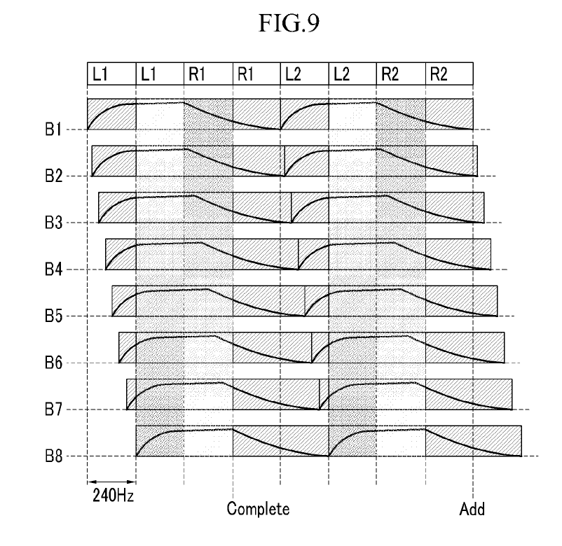

FIG. 9 is a signal waveform diagram of another exemplary embodiment of a 3D image display device according to the invention.

Referring to FIG. 9, left eye images L1 and L2 and right eye images R1 and R2 are alternately inputted based on a frame frequency of 240 Hz. A first left eye image L1 is continuously inputted two times and then, a first right eye image R1 is continuously inputted two times. Next, a second left eye image L2 is continuously inputted two times and then, a second right eye image R2 is continuously inputted two times. In one exemplary embodiment, for example, a white left eye image having a 1023 gray is continuously inputted two times and then, and a black right eye image having a 0 gray is continuously inputted two times. The backlight unit 200 in FIG. 9 is disposed at both upper and lower sides of a display panel 100 and is divided into eight blocks B1 to B8. The eight backlight blocks B1 to B8 are simultaneously turned on and the brightness for each of the eight backlight blocks B1 to B8 is different. In the illustrated embodiment, for example, when the first left eye image L1 is inputted for the second frame time, the backlight unit 200 disposed at the upper side of the display panel 100 gradually brightens toward the first backlight block B1 from the eighth backlight block B8 and the backlight unit 200 disposed at the lower side of the display panel 100 is turned off. When the first right eye image R1 is inputted for the third frame time, the backlight unit 200 disposed at the lower side gradually darkens toward the eighth backlight block B8 from the first backlight block B1 and the backlight unit 200 disposed above is turned off.

A curve in FIG. 9 means gray variation in the image. A slash marked portion in the backlight blocks B1 to B8 in FIG. 9 means that the backlight unit 200 is turned off and a non-slash-mark portion means that the backlight unit 200 has the maximum brightness.

The brightness of the backlight unit 200 for each frame may be independently controlled based on the depth information or the edge information of the input image. In addition, the brightness of each backlight block may be independently controlled even in the same frame based on the depth information or the edge information of the input image. In order to compensate light diffusion deviation, the brightness of each backlight block may be independently controlled in the same frame based on a brightness distribution of the left eye image or the right eye image.

According to the exemplary embodiments of the invention, it may be to reduce a crosstalk effect and improve luminance in the 3D image display device.

While this invention has been described in connection with what is presently considered to be practical exemplary embodiments, it is to be understood that the invention is not limited to the disclosed embodiments, but, on the contrary, is intended to cover various modifications and equivalent arrangements included within the spirit and scope of the appended claims.

What is claimed is:

1. A three dimensional image display device, comprising:
a display panel which displays a left eye image and a right eye image of an image inputted to the display panel, in sequence, the left eye image and the right eye image respectively including an object; and
a backlight unit comprising a plurality of backlight blocks,
wherein based on at least one of
depth information from the objects of the left eye and right eye images, and
edge information from the object of the left eye image or the right eye image,
brightness of the plurality of backlight blocks is independently controlled.

2. The three dimensional image display device of claim 1, wherein:
when the object of the left eye image and the object of the right eye image are the same as each other, and
a difference between a gray of the object of the left eye image and a gray of the object of the right eye image, or a difference between a gray in an edge of the object of the left eye image and a gray in an edge of the object of the right eye image, is greater than a predetermined gray,
brightness of a backlight block corresponding to the object of the left eye image and the object of the right eye image decreases.

3. The three dimensional image display device of claim 2, wherein:
when the difference between the gray of the object of the left eye image and the gray of the object of the right eye image, or the difference between the gray in the edge of the object of the left eye image and the gray in the edge of the object of the right eye image, is smaller than the predetermined gray,
the brightness of the backlight block corresponding to the object of the left eye image and the object of the right eye image increases.

4. The three dimensional image display device of claim 3, wherein:
the left eye image and the right eye image comprise a first region without depth perception, and
a gray of the first region is compensated.

5. The three dimensional image display device of claim 4, wherein:
the brightness of the plurality of backlight blocks is independently controlled based on brightness distribution of the left eye image or brightness distribution of the right eye image.

6. The three dimensional image display device of claim 1, wherein:
a gray of the image inputted to the display panel is controlled based on at least one of
the depth information from the objects of the left eye and right eye images, and
the edge information from the object of the left eye image or the right eye image.

7. The three dimensional image display device of claim 6, wherein:
when the object of the left eye image and the object of the right eye image are the same as each other, and
a difference between a gray of the object of the left eye image and a gray of the object of the right eye image, or a difference between a gray in an edge of the object of the left eye image and a gray in an edge of the object of the right eye image, is greater than a predetermined gray,
the gray of the object of the left eye image or the gray of the object of the right eye image is controlled so as to reduce the difference between the gray of the object of the left eye image and the gray of the object of the right eye image.

8. The three dimensional image display device of claim 7, wherein:
when the difference between the gray of the object of the left eye image and the gray of the object of the right eye image, or the difference between the gray in the edge of the object of the left eye image and the gray in the edge of the object of the right eye image, is smaller than the predetermined gray,
the gray of the object of the left eye image and the gray of the object of the right eye image are not controlled.

9. The three dimensional image display device of claim 8, wherein:
the left eye image and the right eye image comprise a first region without depth perception, and
a gray of the first region is compensated.

10. The three dimensional image display device of claim 6, wherein:
the brightness of the plurality of backlight blocks is independently controlled based on brightness distribution of the left eye image or brightness distribution of the right eye image.

11. The three dimensional image display device of claim 10, wherein:
the backlight unit is on at least one side of the display panel in the plan view.

12. The three dimensional image display device of claim 1, wherein:
a gray of the image inputted to the display panel is controlled based on at least one of
a gray average value of the object of the left eye image or the right eye image,
a gray minimum value of the object of the left eye image or the right eye image,
a gray maximum value of the object of the left eye image or the right eye image,
a high gray average value of the object of the left eye image or the right eye image, and
a low gray average value of the object of the left eye image or the right eye image.

13. The three dimensional image display device of claim 12, wherein:
the left eye image and the right eye image comprise a first region without depth perception, and
a gray of the first region is compensated.

14. The three dimensional image display device of claim 12, wherein:
the brightness of the plurality of backlight blocks is independently controlled based on brightness distribution of the left eye image or brightness distribution of the right eye image.

15. The three dimensional image display device of claim 14, wherein:
the backlight unit is on at least one side of the display panel in a plan view.

16. A driving method of a three dimensional image display device, the method comprising:
displaying a left eye image and a right eye image of an image inputted to a display panel, in sequence; and
independently controlling brightness of a plurality of backlight blocks based on at least one of
depth information from the objects of the left eye and right eye images, and
edge information from the object of the left eye image or the right eye image.

17. The method of claim 16, wherein the independently controlling brightness of a plurality of backlight blocks comprises:
decreasing the brightness of a backlight block corresponding to the object of the left eye image and the object of the right eye image when
the object of the left eye image and the object of the right eye image are the same as each other, and
a difference between a gray of the object of the left eye image and a gray of the object of the right eye image, or a difference between a gray in an edge of the object of the left eye image and a gray in an edge of the object of the right eye image, is greater than a predetermined gray.

18. The method of claim 16, wherein:
the brightness of the plurality of backlight blocks is independently controlled based on brightness distribution of the left eye image and brightness distribution of the right eye image.

19. The method of claim 18, wherein:
a gray of the image inputted to the display panel is controlled based on at least one of
the depth information from the objects of the left eye and right eye images, and
the edge information from the object of the left eye image or the right eye image.

20. The method of claim 18, wherein:
a gray of the image inputted to the display panel is controlled based on at least one of
a gray average value of the object of the left eye image or the right eye image,
a gray minimum value of the object of the left eye image or the right eye image,
a gray maximum value of the object of the left eye image or the right eye image,
a high gray average value of the object of the left eye image or the right eye image, and
a low gray average value of the object of the left eye image or the right eye image.
